(19) United States
(12) Patent Application Publication
(10) Pub. No.: US 2026/0334455 A1
(43) Pub. Date: Oct. 29, 2026

(54) SIDING PEST INTRUSION BARRIER

(71) Applicant: AAC DISTRIBUTING, LLC, Syracuse, IN (US)

(72) Inventors: Mattison Scott Siri, Elkhart, IN (US); Anthony Michael Siri, Syrracuse, IN (US)

(73) Assignee: AAC DISTRIBUTING, LLC, Syracuse, IN (US)

(21) Appl. No.: 19/549,665

(22) Filed: Feb. 25, 2026

Related U.S. Application Data
(60) Provisional application No. 63/764,305, filed on Feb. 27, 2025.

(51) Int. Cl. A01M 29/30; E04B 1/72

(52) U.S. Cl. CPC A01M 29/30; E04B 1/72

(57) ABSTRACT

A siding pest intrusion barrier having an elongate pest shield has an upper barrier portion that includes a first serrated edge. The first serrated edge has a plurality of teeth that are separated by valleys. The upper barrier portion extends from the first serrated edge to an upper bend. An offsetting portion extends from the upper bend to a middle bend. The offsetting portion is angled with respect to the upper barrier locating the teeth of the upper barrier portion at a spaced distance from the upper barrier portion. A sheathing protection portion extends from the middle bend to a lower bend. A fastener may be driven through the sheathing protection portion. A foundation protection portion extends from the lower bend to a second serrated edge that has a plurality of teeth separated by valleys. The pest intrusion barrier is useful near the lower edge of siding.

### CROSS REFERENCE TO RELATED APPLICATIONS

This application is a Utility of the U.S. application Ser. No. 63/764,305, filed Feb. 27, 2025, and claims the priority thereof and is hereby incorporated in its entirety by reference.

### BACKGROUND OF THE INVENTION

Siding has been used on homes for a long time. Siding can be an alternative to masonry exteriors and is significantly less expensive. The durable nature of masonry exteriors is inherently pest resistant because pests cannot easily penetrate such an exterior. However, siding can provide opportunities for pests to enter. Opportunistic pests, such as rodents, have demonstrated their ability to enter siding near the lowest portions of the siding. Typical siding is installed from the bottom up. During the installation process a starter strip is installed near the foundation on which a structure, such as a house, rests. The starter strip is fastened to sheathing that is fastened to the studs of the wall. The starter strip and the siding affixed to it can leave an exposed gap below the first course of siding that is attached to the starter strip and sheathing. This gap is a frequent pathway for rodents to enter a structure. The sheathing may be something upon which opportunistic rodents can gnaw through to then gain entry to the sided structure.

Filling the gap between the siding and the foundation that leaves the sheathing vulnerable to rodents is important to keep them out of the structure. Others have attempted to fill the gap with barriers that sometimes slow rodents down. Foam has been used to fill the gap and sometimes the foam is impregnated with materials that repel rodents or make chewing on the foam undesirable. This is not always a certain preventive measure and rodents can work their way through such materials. Over time, such materials can degrade and this will allow rodents access to the structure when they gnaw through the sheathing that is exposed adjacent to the lowest course of siding and the foundation. Metal mesh or metal wool has been tried and is somewhat successful, but is not always reliable and is subject to being pulled from the gap near the foundation. Such metal mesh and wool products can be slow and difficult to install. There remains an unmet need for a robust and easy to install system that reliably eliminates the entry of rodents near the bottom of siding.

### SUMMARY OF THE INVENTION

A siding pest intrusion barrier for use with siding overlaying sheathing that is adjacent to a foundation having a top surface and an outer surface. The sheathing has a lower lateral edge that is adjacent to the foundation. The lower lateral edge of the sheathing has a portion that extends beyond the outer surface of the foundation. A portion of the sheathing is covered by the siding that includes a hooked end for interlocking with a starter strip. The starter strip has a mounting portion that is for being affied to the sheathing and a retention end for interlocking with the hoked end of the siding. An elongate pest shield has an upper barrier portion that includes a first serrated edge. The first serrated edge has a plurality of teeth that are separated by valleys. The upper barrier portion extends from the first serrated edge to an upper bend. An offsetting portion extends from the upper bend to a middle bend. The offsetting portion is angled with respect to the upper barrier. This locates the teeth of the upper barrier portion at a spaced distance from the upper barrier portion. A sheathing protection portion extends from the middle bend to a lower bend. A fastener may be driven through the sheathing protection portion and into the sheathing. A foundation protection portion extends from the lower bend to a second serrated edge that has a plurality of teeth separated by valleys.

### BRIEF DESCRIPTION OF THE DRAWINGS

FIG. 1 is a sectional view of a wall not showing the studs near the foundation where the foundation meets the structure sitting upon the foundation;

FIG. 2 is a magnified view of the wall shown in FIG. 1 with the pest intrusion at a first step of installation;

FIG. 3 is the view of the wall shown in FIG. 2 with the elongate strip of the pest intrusion system inserted between the starter strip and the sheathing;

FIG. 4 is the view of the wall shown in FIG. 3 with the elongate strip of the pest intrusion system further inserted between the starter strip and the sheathing than shown in FIG. 3;

FIG. 5 is the installed position of the elongate strip and the installed position of the starter strip that corresponds to the position of the starter strip when the elongate strip is fully installed;

FIG. 6 is a perspective view of the elongate strip shown in FIGS. 1-5;

FIG. 7 is a magnified view of the elongate strip shown in FIG. 6;

FIG. 8 is an end view of the elongate strip shown in FIG. 7;

FIG. 9 is a sectional view of an elongate strip that is generally used for being incorporated in a structure as it is being built;

FIG. 10 is a perspective view of the elongate strip shown in FIG. 9;

FIG. 11 is a sectional view of an elongate strip that has an upper barrier portion near the offsetting portion for tightly holding the terminal end of siding; and

FIG. 12 is a perspective view of the elongate strip shown in FIG. 11.

### DETAILED DESCRIPTION OF INVENTION

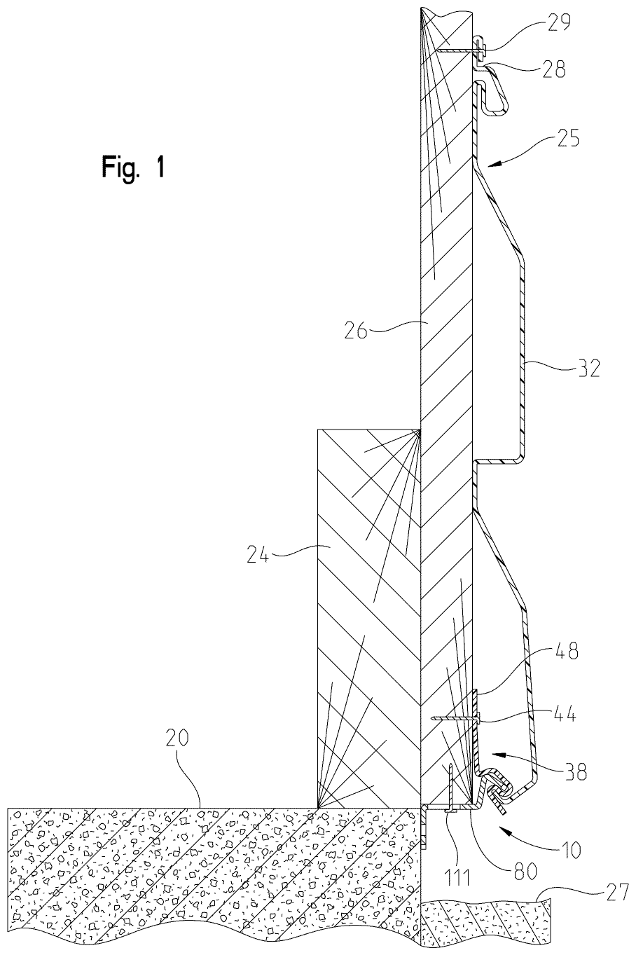

A siding pest intrusion barrier system 10 is shown in FIG. 1 and is attached near the foundation 14 of an existing structure. The siding pest intrusion barrier system 10 is applicable to many different walls and foundation construction systems which are described below. For clarity, not all of the parts of every type of foundation 14 and wall system are shown. The foundation 14 shown may be slab, traditional basement, or a crawl space. In any configuration of a foundation 14, it will have a top surface 20 upon which the structure will rest. Additionally, all foundation types will have an outer surface 16 that faces the exterior of the structure. The main differences between the aforementioned foundation 14 types are merely the thickness of the foundation 14 laterally toward the interior of the structure. In the case of a slab type foundation (which is not depicted in the FIGS.) the top surface 20 will correspond to the floor of the structure. Another difference between foundations, and even those within the same type, is the height of the top surface 20 above the ground that is adjacent to the foundation 14. The foundation 14 depicted in the FIGS. corresponds to a crawl space or basement wall type foundation 14. In the configuration shown, the structure will typically have a rim joist 24 that could possibly sit upon a sill plate (which is not shown in the FIGS.). The rim joist 24 is well known in construction to be the lowermost portion of a wall 25 in home construction and is adjacent to the ends of floor joists (not shown). The rim joist 24 forms a perimeter of a home at its lowermost portion adjacent the foundation 14. Sheathing 26 is installed over the rim joist 24 and directly over the studs (not shown) of the walls 25 that extend above the rim joist 24. In the case of a slab foundation, sheathing 26 will also be adjacent to the top surface 20 and near the ground 27 adjacent to the foundation 14. The sheathing 26 may be made from plywood, oriented strand board (“OSB”), or insulation board. The sheathing 26 is intended to be a defense from the intrusion of the elements and a defense from pests that will work diligently to enter through the sheathing 26 to obtain access to the interior of the structure.

The sheathing 26 is not the outermost part of an exterior wall of a structure. Typically, the sheathing 26 is not designed to handle exterior weather conditions directly and the sheathing 26 is covered by siding 32 that protects the sheathing 26 from the elements. That siding 32 can be vinyl siding 32 or may be aluminum siding 32. In either case, the siding 32 is installed in an overlapping pattern from the bottom of the wall with each successive course of siding 32 interlocking with the course below. The first course of siding 32 that is shown in the FIGS. is secured to the sheathing 26 with the use of a starter strip 38 that is affixed to the sheathing 26. The top of the siding 32 has a mounting portion 28 through which fasteners 29 are driven. The first course of siding 32 is shown in the FIGS. because this is the portion of the siding 32 that is most susceptible to pest intrusion. The sheathing 26 has a lower lateral edge 40 that is often aligned with the top surface 20 of the foundation 14. The lower lateral edge 40 is not always aligned with the top surface 20 and, in some cases, the lower lateral edge 40 could overlap the outer surface 16 of the foundation 14 to a location below the top surface 20. The starter strip 38 is affixed to the sheathing 26 with fasteners 44 which are often nails or screws that are driven into the sheathing 26 through a mounting portion 48 of the starter strip 38 to hold it to the sheathing 26. The part of the starter strip 38 opposite the mounting portion 48 is the retaining end 49. The retaining end 49 of the starter strip 38 as shown has an offset wall 50 that is located outwardly of the mounting portion 48. The offset wall 50 continues around into a terminal curved wall 54. The terminal curved wall 54 continues into a retention pocket 58. The retention pocket 58 has a first retention wall 62 that extends from the terminal curved wall 54 and is connected by a bottom wall 68 (that defines the bottom of the retention pocket 58). A second retention wall 70 is spaced from the first retention wall 62 and is part of the starter strip 38 designed to affirmatively engage and retain the siding 32 within the retention pocket 58. The siding 32 has a terminal end 66 that is in the shape of a hook and held within the retention pocket 58. It is contemplated in some starter strips 38 the terminal curved wall 54 may be the end of the starter strip 38 and there may not be a retention pocket 58. In such systems, the siding 32 just hooks over the terminal curved wall 54 or other end structure of such a starter strip 38. The starter strip 38 of any type of system is designed to keep the terminal end 66 of the siding 32 adjacent to the sheathing 26.

The siding pest intrusion prevention system 10 includes an elongate strip 80 that is designed to be installed adjacent to the lower lateral edge 40 of the sheathing 26, which often serves as a location where pests (particularly rodents) desire to enter a building having siding 32, as shown in the FIGS. The elongate strip 80 is made of metal, but could also be made of a durable plastic or other material. The elongate strip 80 has an upper barrier portion 86 that includes a first serrated edge 84 that has teeth 87 that are separated by valleys 88. The teeth 87 end in sharp points. The upper barrier portion 86 extends to an upper bend 90. The upper bend 90 is connected to an offsetting portion 94. The offsetting portion 94 extends from the upper bend 90 to a middle bend 96. The middle bend 96 is connected to a sheathing protection portion 106. The sheathing protection portion 106 has a series of holes 108 therethrough. The holes 108 are elongated so that fasteners 111 may be driven through the holes 108 at various lateral locations with respect to the sheathing protection portion 106. The holes 108 may also serve as drainage holes in the event water gets behind the siding 32 above the intrusion barrier system 10. The sheathing protection portion 106 is connected to a lower bend 110 that is connected to a foundation protection portion 116. The foundation protection portion 116 continues from the lower bend 110 to a second serrated edge 122. The second serrated edge 122 has teeth 124 and valleys 126 just like the first serrated edge 84. Although first and second serrated edges 84, 122 are used in the elongate strip 80, doing so is not absolutely necessary. Having the elongate strip 80 itself is a significant barrier that prevents the intrusion of pests and the serrated edges 84, 122 provides another significant disincentive for pests to move past the elongate strip 80.

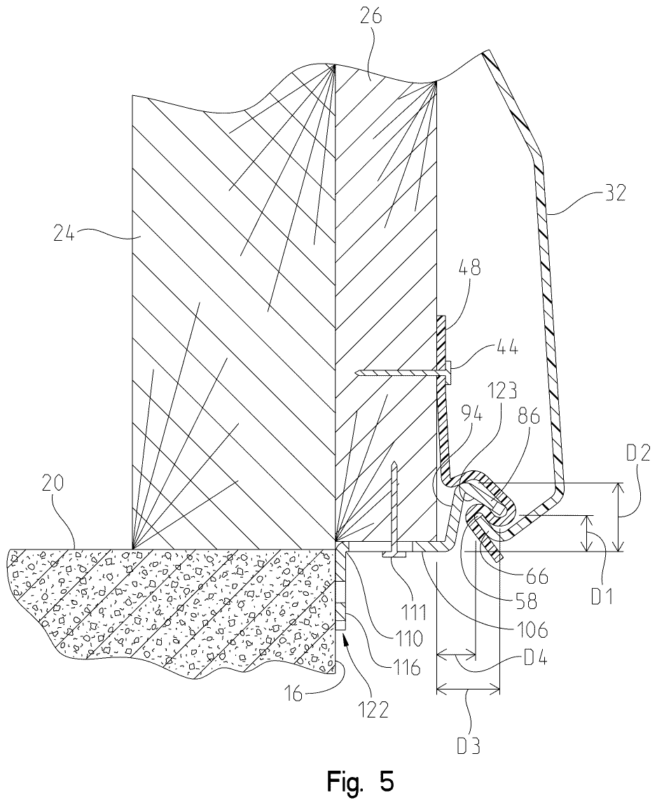

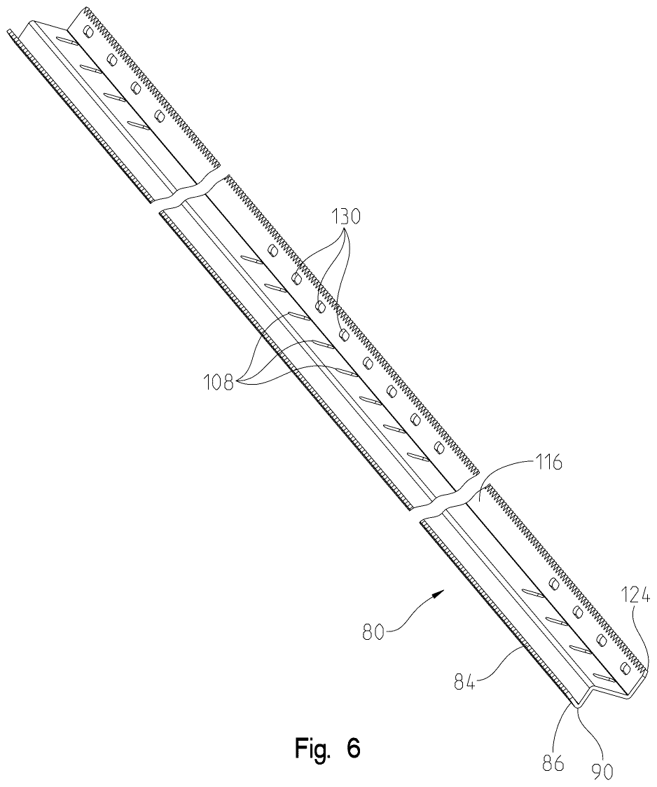

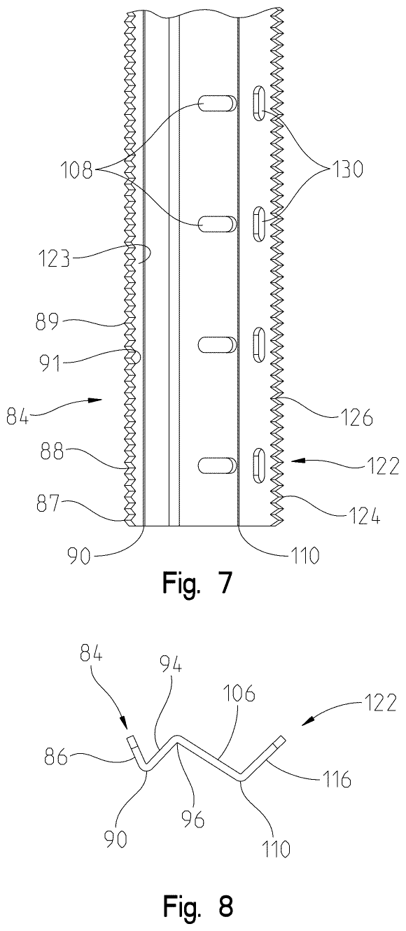

The bends 90, 96, 110 define important relationships in the elongate strip 80 that make it particularly effective for its intended purpose. The upper bend 90 is at an acute angle between the upper barrier portion 86 and the offsetting portion 94. This locates the teeth 87 of the first serrated edge 84 nearer to the sheathing protection portion 106 than the upper bend 90 when the elongate strip 80 is in its installed position. As such, the teeth 87 are angled downwardly. This downward angle, due to the upper bend 90, locates the underside 123 of the upper barrier portion 86 which is angled downwardly so that the points 89 of the teeth 87 that extend through the thickness of the upper barrier portion 86 are angled downwardly. The points 89 of the teeth 87 where they meet the underside 123 of the upper barrier portion 86 also point downwardly in the installed position of the elongate strip 80. This reveals an apex 91 of the teeth 87. The apexes 91 are where each of the points 89 of the teeth 87 meet the underside 123 of the upper barrier portion 86. The apexes 91 face in a downward and biting direction, much like the teeth 87 themselves. The offsetting portion 94 locates the teeth 87 at a height between the upper bend 90 and the sheathing protection portion 106 when the elongate strip 80 is in the installed position. As seen in FIG. 5, the height of the upper bend 90, above the sheathing protection portion 106, is located at D2 and the height of the teeth 87 on the first serrated edge 84 is located at D1. Both D1 and D2 are located above the lower lateral edge 40 of the sheathing 26 in the installed position of the elongate strip 80. The angle of the offsetting portion 94 and the sheathing protection portion 106 is slightly obtuse. As such, when the elongate strip 80 is in its installed position, the offsetting portion 94 will be angled away from the sheathing 26. This relationship will still locate the offsetting portion 94 to be spaced from the sheathing 26 in the event that the middle bend 96 contacts the outer corner 125 of the lower lateral edge 40 of the sheathing 26. The lower bend 110 is slightly obtuse in its uninstalled position. The foundation protection portion 116 also has a series of elongate holes 130 therethrough. These holes 130 serve as another location for fasteners 111 should they be desired to be used.

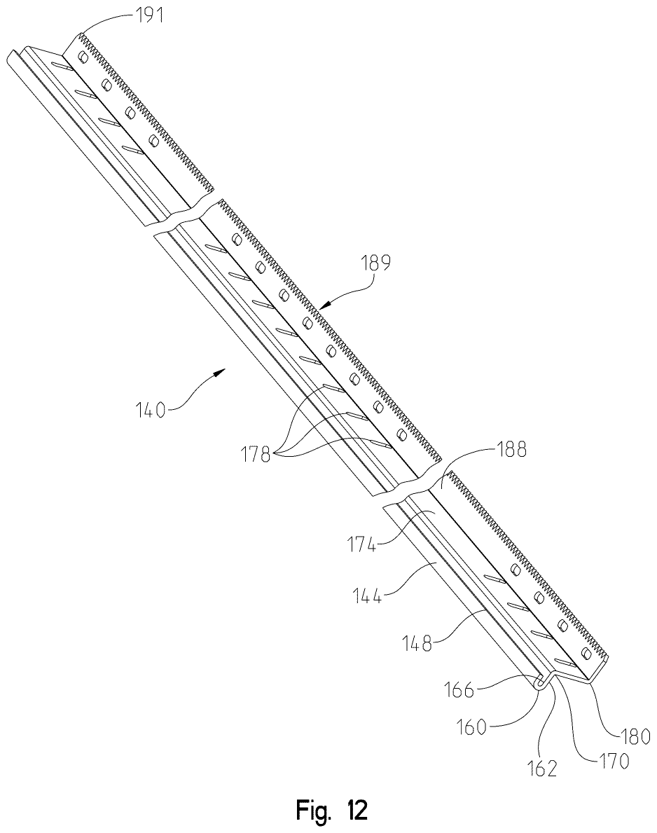

An elongate strip 140 that is much like elongate strip 80 may also be used. This is shown in FIGS. 11 and 12. The elongate strip 140 is somewhat different in that it may be used in applications where the thickness of the sheathing 26 is known. The elongate strip 140 is also made of metal, but can be made of a durable plastic or other material. The elongate strip 140 has an upper barrier portion 144 that has a first serrated edge 148 that may have teeth as mentioned above. The use of the teeth on the first serrated edge 148 is not absolutely necessary due to the fit of the elongate strip with the siding 32. The upper barrier portion 144 extends to an upper bend 160. The upper bend 160 is connected to an offsetting portion 162. In the case of the elongate strip 140, the upper barrier portion 144 and the offsetting portion 162 are substantially parallel to each other and define a retention pocket 166 that is for engaging the terminal end 66 of the siding 32 that forms a hook to engage the retention pocket 166 of the elongate strip 140. The offsetting portion 162 extends to a middle bend 170. The middle bend 170 is connected to a sheathing protection portion 174. The sheathing protection portion 174 has a series of holes 178 therethrough. The holes 178 are elongated so that fasteners 111 may be driven through the holes 178 at various locations. The holes 178 may serve as drainage holes in the event that water gets behind the siding 32 above the barrier system 10. The sheathing protection 174 is connected to a lower bend 180. The middle bend 170 and lower bend 180 define the width of the sheathing protection portion 174. It should be noted that the sheathing protection portion 174 is the approximate width that corresponds to the thickness of the sheathing 26. This enables the offsetting portion 162 and a foundation protection portion 188 to both rest upon their respective adjacent surfaces of the sheathing 26 and against the foundation 20, as shown in FIG. 11. The foundation protection portion 188 ends in a second serrated edge 189 having teeth 191. In cases where the thickness of the sheathing 26 is a known thickness, which is often a standard size such as 7/16 inch or ½ inch, the elongate strip 140 provides a tight fit to the sheathing 26 and foundation 20.

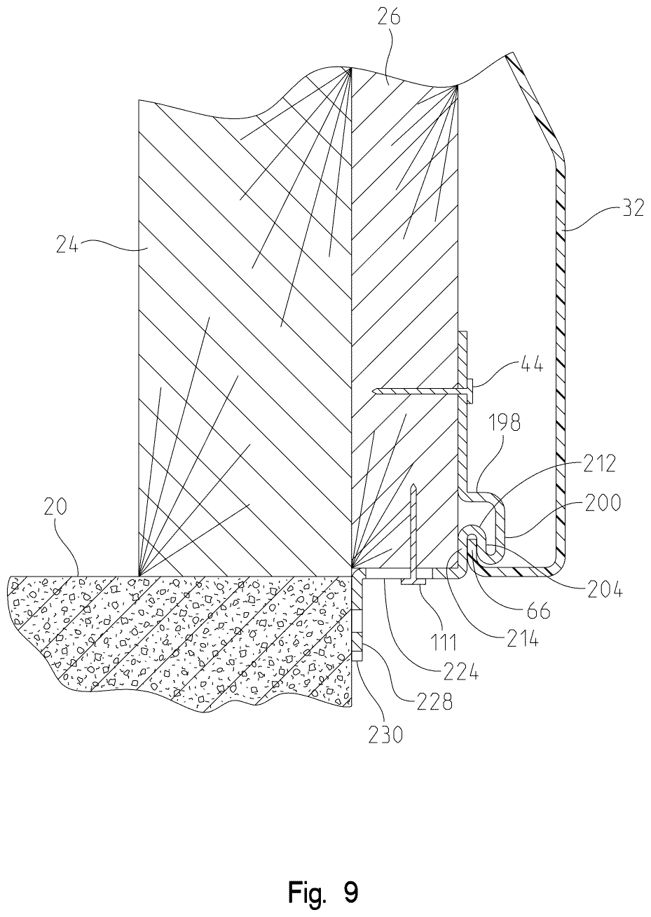

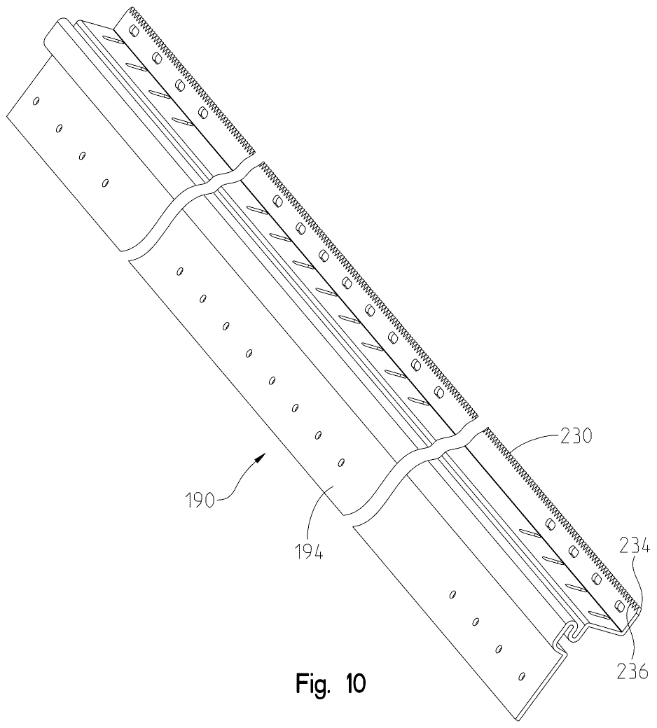

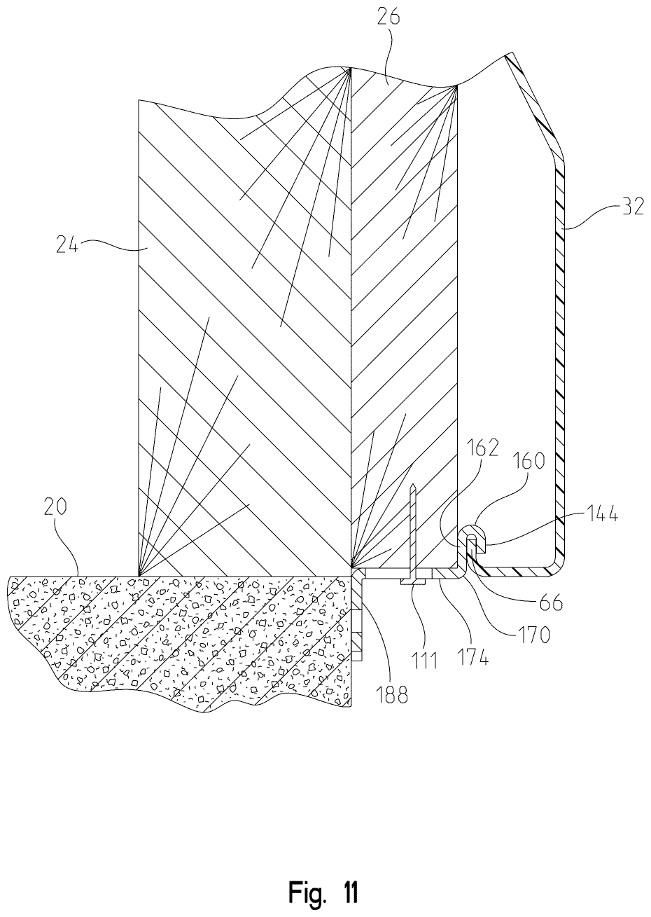

Elongate strip 190, shown in FIGS. 9 and 10, may also be used when it is incorporated as a home or structure that is being built as opposed to being retrofitted. Elongate strip 190 includes features of the starter strip 38 and features to prevent rodent intrusion into the siding 32. Elongate strip 190 includes a mounting portion 194 for receiving fasteners 44 that are driven into the sheathing 26. The mounting portion 194 continues into a standoff wall 198 that is nearly perpendicular to the mounting portion 194. The standoff wall 198 continues into an offset wall 200 that is substantially parallel to the sheathing 26 and the offset wall 200 is spaced from the sheathing 26. The offset wall 200 is connected to a first retention wall 204 that is located between the mounting portion 194 and the offset wall 200. The offset wall 200 is the outermost portion of the elongate strip 190 with respect to the mounting portion 194 and with respect to the sheathing 26 to which the elongate strip 190 is mounted. The first retention wall 204 is connected by a bridge 212 to a second retention wall 214 that is parallel to the first retention wall 204 and defines a retention pocket 220 that is for receiving and retaining the terminal end 66 of the siding 32. The second retention wall 214 continues down to a sheathing protection portion 224 that is perpendicular to the second retention wall 214. The sheathing protection portion 224 is connected to a foundation protection portion 228. The foundation protection portion 228 includes a serrated edge 230 having teeth 234 separated by valleys 236 as discussed above. The serrated edge 230 is the lowermost edge of the elongate strip 190. It is contemplated that the lowermost edge of the elongate strip 190, that is shown as the serrated edge 230, does not have teeth.

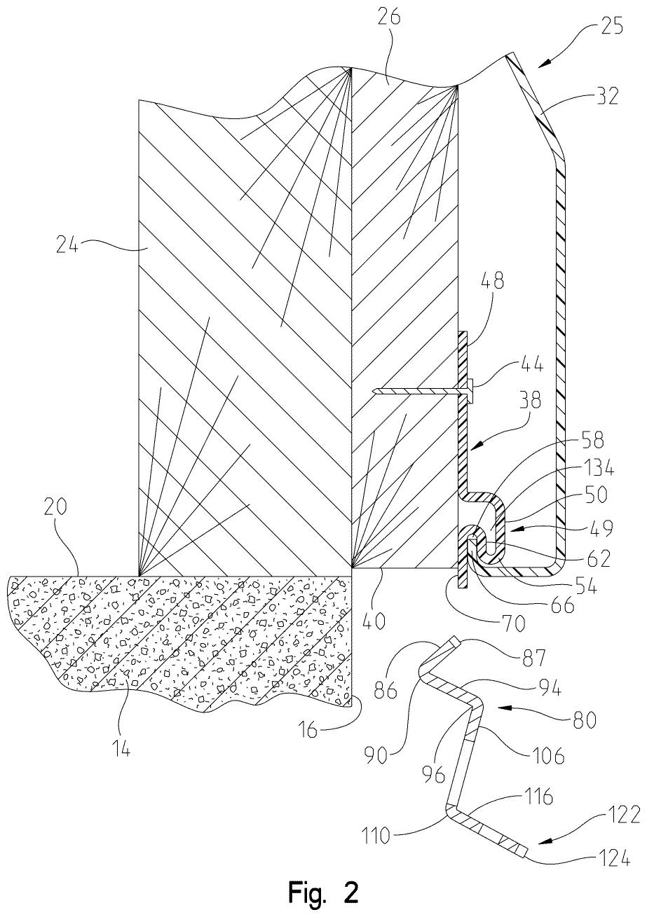

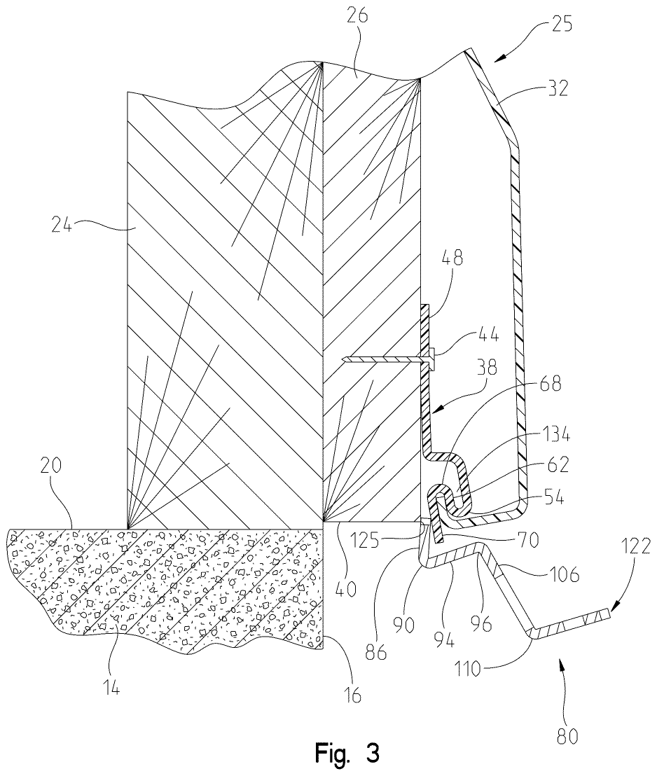

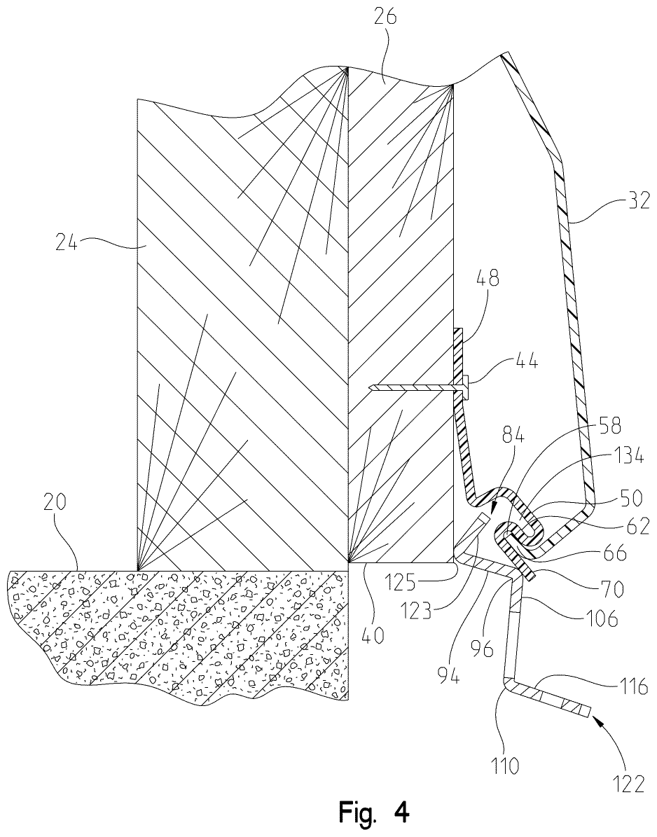

Installation of the elongate strip 80 of the pest intrusion prevention system 10 is typically done on an existing home or other structure. FIG. 2 shows how the elongate strip 80 is positioned at the beginning of its installation. The elongate strip 80 is fed upwardly toward the lower lateral edge 40 of the sheathing 26 and adjacent to the retaining end 49 of the starter strip 38. FIG. 2 also shows the starter strip 38 in what is an uninstalled position that corresponds to the elongate strip 80 not being installed; this is the unprotected state of the starter strip 38 and sheathing 26 as it would be in the absence of the pest intrusion prevention system 10. FIG. 3 shows how the first serrated edge 84 is inserted in direct contact with the retention end 49 of the starter strip 38 and the sheathing 26. Specifically, the first serrated edge 84 and the upper barrier portion 86 are used to bend the starter strip 38 outwardly of the sheathing 26 through initial contact at the second retention wall 70 of the starter strip 38. The feeding of the elongate strip 80 against the starter strip 38 is done in a manner that puts the first serrated edge 84 in biased contact with the starter strip 38. The starter strip 38 is resilient and has a bias toward returning its uninstalled position that is shown in FIG. 2. As shown in FIG. 4, the first serrated edge 84 is brought further upwardly between the offset wall 50 and the sheathing 26. This positions the first serrated edge 84 above the lower lateral edge 40 of the sheathing 26. The elongate strip 80 is rotated to locate the foundation protection portion 116 adjacent to the outer surface 16 of the foundation 14. Then, as shown in FIG. 5, the first serrated edge 84 is brought into contact with the offset wall 50 in a manner that pushes it away from the sheathing 26. This puts the first serrated edge 84 in biased contact with the inside of the offset wall 50. The upper barrier portion 86 becomes interlocked into an outer pocket 134 of the starter strip 38. This outer pocket 134 is the result of the S-shaped configuration at the retention end 49 of the starter strip 38. Once the elongate strip 80 is moved into the position shown in FIG. 5, fasteners 111 are driven into the lower lateral edge 40 of the sheathing 26. This locking of the elongate strip 80 with the fasteners 111 ensures that the first serrated edge 84 is interlocked with the outer pocket 134 at the retention end 49 of the starter strip 38. This interlocking fit of the first serrated edge 84 and the outer pocket 134 prevents the starter strip 38 and the siding 32 held by the starter strip from being pulled out any further than the installed position, as shown in FIG. 5. The interlocking fit of the first serrated edge 87 with the starter strip 38 is made possible because the first serrated edge 87 is located at distance D3 from the sheathing 26 that is greater than the distance D4 that the terminal end 66 of the siding 28 is from the sheathing 26. This installed position is shown in FIG. 5 and ensures that a pest attempting to gain access to the interior of a structure through the sheathing would necessarily engage the teeth 87 that are tightly biased against the starter strip 38 and located outwardly of the terminal end 66 of the siding 28. A pest, such as a rodent, encountering the teeth 87 would be significantly deterred from attempting to move past the first serrated edge 84. Additionally, the interlocking nature of the teeth 87 within the outer pocket 134 requires a torturous path up around the second retention wall 70. A pest would necessarily need to travel up to the top of the second retention wall 70, then somewhat downwardly into the outer pocket 134, and then back around over the teeth 87. The pest would encounter the sharp vertexes 91 of the teeth 87 where they meet the underside 123 of the upper barrier portion 86, as well as be impaled by the teeth 87 at their points 89 along the entire first serrated edge 84. Similar protection is provided adjacent to the outer surface 16 of the foundation 14. As mentioned above, the lower bend 110 is slightly obtuse and this allows the teeth 124 on the second serrated edge 122 to contact the outer surface 16 of the foundation 14 before any other part of the elongate strip 80. When the elongate strip 80 is installed, it is pushed toward the outer surface 16 of the foundation 14 so that the teeth 124 on the foundation protection portion 116 are biased against the outer surface 16. This bias provides a tight seal of the teeth 124 against the foundation 14 so that pests cannot work their way between the teeth 124 and the foundation 14.

Installation of the pest intrusion system 10 is relatively straightforward and provides effective protection from opportunistic pests attempting to enter a structure near the foundation 14. As discussed above, a first elongate strip 80 is positioned so that the first serrated edge 84 and the teeth 87 thereon are located near the retaining end 49 of the starter strip 38. An installer will then insert the first serrated edge 84 between the sheathing 26 and the second retention wall 70 of the starter strip 38, as shown in FIG. 3. The user can then use the leverage of the entire elongate strip 80 to pry the starter strip 38 away from the sheathing 26, as shown in FIG. 4. This will move the starter strip 38 away from its uninstalled position and create a biasing force that will constantly push against the elongate strip 80. Once the elongate strip 80 has been rotated so that the first serrated edge 84 is interlocked with the starter strip 38, the elongate strip 80 is shifted toward the outer surface 16 of the foundation 14. Because the lower bend 110 is slightly obtuse with respect to the sheathing protection portion 106, the teeth 124 on the second serrated edge 122 contact the outer surface 16 of the foundation 14 in a biased manner when the elongate strip 80 is pushed toward the foundation 14. With the teeth 124 being biased against the foundation 14, fasteners 111 are driven through the holes 108. The fasteners 111 can be driven partially into the sheathing 26 to lightly hold the elongate strip 80 near its final installed position. Then, the fasteners 111 can be driven into their final positions once the elongate strip 80 is pressed tightly against the foundation 14. The teeth 124 will finally be biased tightly against the foundation 14. In the installed position of the elongate strip 80, the offsetting portion 106 extends upwardly of the lower lateral edge 40 of the sheathing 26 and the foundation protection portion 116 extends downwardly in an opposite direction to the offsetting portion 94. Multiple elongate strips 80 are overlapped to cover the entire exposed lower lateral edge 40 of a structure. The holes 108, 130 are in a repeating pattern so that an installer can choose how much overlap is necessary to completely cover the lower lateral edge 40. The holes 130 can accommodate fasteners 111 in the event an installer wants to ensure that the teeth 124 are fully biased against the foundation 14. However, it is only necessary to have fasteners 111 driven through the sheathing protection portion 116.

What is claimed is:

1. A siding pest intrusion prevention system in combination with siding overlaying sheathing that is adjacent to a foundation having a top surface and an outer surface, said sheathing having a lower lateral edge adjacent to said foundation and said lower lateral edge of said sheathing having a portion of said lower lateral edge extending beyond said outer surface of said foundation, a portion of said sheathing being covered by siding that includes a hooked end for interlocking with a starter strip, said starter strip having a mounting portion for being affixed to said sheathing and a retention end for interlocking with said hooked end of said siding, said siding pest intrusion prevention system comprising:
an elongate pest shield having an upper barrier portion including a first serrated edge having a plurality of teeth separated by valleys, said upper barrier portion extending from said first serrated edge to an upper bend, an offsetting portion extending from said upper bend to a middle bend, said offsetting portion being angled with respect to said upper barrier portion so that said teeth of said upper barrier portion are spaced from said offsetting portion, a sheathing protection portion extending from said middle bend to a lower bend, a foundation protection portion extending from said lower bend to a second serrated edge having a plurality of teeth separated by valleys.

2. The siding pest intrusion prevention system of claim 1, wherein said sheathing protection portion includes a mounting aperture for receiving a fastener driven through said sheathing protection portion and into said sheathing

3. The siding pest intrusion prevention system of claim 1, wherein said elongate pest shield is a first elongate pest shield and a second elongate pest shield is overlapped with said first pest shield.

4. A siding pest intrusion system prevention system in combination with siding overlaying sheathing that is adjacent to a foundation having a top surface and an outer surface, said sheathing having a lower lateral edge adjacent to said foundation and said lower lateral edge of said sheathing having a portion of said lower lateral edge extending beyond said outer surface of said foundation, a portion of said sheathing adjacent to said foundation being covered by siding that includes a hooked end for interlocking with a starter strip, said starter strip having a mounting portion for being affixed to said sheathing and a retention end for interlocking with said hooked end of said siding, said starter strip having an uninstalled position wherein said retention end is located at a first distance from said sheathing and an installed position corresponding to said pest intrusion system being installed wherein said retention end is located at a second distance that farther than said first distance, said siding pest intrusion prevention system comprising:
an elongate pest shield having an upper barrier portion including a first serrated edge having a plurality of teeth separated by valleys, said upper barrier portion having an underside, said upper barrier portion extending from said first serrated edge to an upper bend, an offsetting portion extending from said upper bend to a middle bend and said underside of said upper barrier portion forming an acute angle with respect to said offsetting portion and said teeth of said upper barrier portion being spaced from said offsetting portion, a sheathing protection portion extending from said middle bend to a lower bend and said sheathing protection portion including a mounting aperture for receiving a fastener driven through said sheathing protection portion and into said sheathing, a foundation protection portion extending from said lower bend to a second serrated edge having a plurality of teeth separated by valleys, said foundation protection portion extending in an opposite direction of said sheathing protection portion to that of said offsetting portion and said second serrated edge extending beyond said lower lateral edge of said sheathing in an opposite direction as said offsetting portion, said sheathing protection portion contacting said lower lateral edge of said sheathing and said foundation protection portion contacting said foundation, said starter strip in said installed position and in biased contact with said first serrated edge of said elongate pest shield.

5. The siding pest intrusion system prevention system of claim 4, wherein said hooked end of said siding is at a first outward distance from said sheathing and said first serrated edge is at a second outward distance from said sheathing, said second outward distance being greater than said first outward distance.

6. A pest intrusion barrier for use with siding overlaying sheathing that is adjacent to a foundation having a top surface and an outer surface, said sheathing having a lower lateral edge adjacent to said foundation and said lower lateral edge of said sheathing having a portion of said lower lateral edge extending beyond said outer surface of said foundation, a portion of said sheathing being covered by siding that includes a hooked end for interlocking with a starter strip, said starter strip having a mounting portion for being affixed to said sheathing and a retention end for interlocking with said hooked end of said siding, said pest intrusion barrier comprising:
an elongate pest shield having an upper barrier portion including a first serrated edge having a plurality of teeth separated by valleys, said upper barrier portion extending from said first serrated edge to an upper bend, an offsetting portion extending from said upper bend to a middle bend, said offsetting portion being angled with respect to said upper barrier portion so that said teeth of said upper barrier portion are spaced from said offsetting portion, a sheathing protection portion extending from said middle bend to a lower bend, a foundation protection portion extending from said lower bend to a second serrated edge having a plurality of teeth separated by valleys.

7. The pest intrusion barrier of claim 6, wherein said sheathing protection portion includes a mounting aperture for receiving a fastener driven through said sheathing protection portion and into said sheathing

8. The pest intrusion barrier of claim 7, wherein said upper barrier portion is at an acute angle with respect to said offsetting portion.

9. The pest intrusion barrier of claim 8, wherein said hooked end of said siding is at a first outward distance from said sheathing and said first serrated edge is at a second outward distance from said sheathing, said second outward distance being greater than said first outward distance.

10. The pest intrusion barrier of claim 8, wherein said elongate pest shield is a first elongate pest shield and a second elongate pest shield is overlapped with said first pest shield.

11. A pest intrusion barrier for use with siding overlaying sheathing that is adjacent to a foundation having a top surface and an outer surface, said sheathing having a lower lateral edge adjacent to said foundation and said lower lateral edge of said sheathing having a portion of said lower lateral edge extending beyond said outer surface of said foundation, a portion of said sheathing being covered by siding that includes a hooked end, said pest intrusion barrier comprising:
an elongate pest shield having an upper barrier portion including a first serrated edge having a plurality of teeth separated by valleys, said upper barrier portion extending from said first serrated edge to an upper bend, an offsetting portion extending from said upper bend to a middle bend, said offsetting portion being offset from said with respect to said upper barrier portion so that said teeth of said upper barrier portion are spaced from said offsetting portion, a sheathing protection portion extending from said middle bend to a lower bend, a foundation protection portion extending from said lower bend to a second edge.

12. The pest intrusion barrier of claim 11, wherein said upper barrier portion is substantially parallel to said offsetting portion.

13. The pest intrusion barrier of claim 12, wherein said sheathing protection portion includes a mounting aperture for receiving a fastener driven through said sheathing protection portion and into said sheathing.

14. The pest intrusion barrier of claim 11, wherein said hooked end of said siding is at a first outward distance from said sheathing and said first serrated edge is at a second outward distance from said sheathing, said second distance being greater than said first distance.
